(19) United States
(12) Patent Application Publication
(10) Pub. No.: US 2023/0131191 A1
(43) Pub. Date: Apr. 27, 2023

(54) Drone Trailer System

(71) Applicant: Lawrence Fleming, Lake Elsinore, CA (US)

(72) Inventor: Lawrence Fleming, Lake Elsinore, CA (US)

(21) Appl. No.: 17/509,022

(22) Filed: Oct. 24, 2021

(51) Int. Cl. B64D 9/00

(52) U.S. Cl. CPC B64D 9/00

(57) ABSTRACT

Disclosed is a drone trailer system and associated methods. The system includes a control section, which maneuvers the drone, and a utility section, which may serve one or more functions. The utility section may be connected to an articulated joint, which may be connected to the control section. The articulated joint may be detachably or fixedly connected to the control section. The payload of the utility section may include an electronic sign, a printed sign, a solar panel, or a camera. A stabilization device may stabilize the utility section's movement relative to the utility section. Further, the stabilization device may allow a user to orient the utility section relative to the control section in two or more orientations. The articulated joint may allow the control section to pitch and roll, or, alternatively, pitch, roll, and yaw relative to the utility section.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### Field

The present invention relates to airborne drones, and specifically to airborne drones which carry payloads.

### Background

Unmanned anal vehicles of various sizes are becoming increasingly popular. While some of these aircraft are for recreation only, other versions are designed for various purposes. Many of these purposes are military, because of the possibility of increased endurance and reduced risk to human operators. However, there are several uses beyond recreation for the civilian market as well.

These uses include entertainment with drones flying in formation to display messages and provide lighting effects. Additional uses can include visual recording, for example, for real estate sales. Finally, some companies have contemplated and provided pilot programs of delivery of goods by drone. Of course, these are but a few examples, and do not provide an exhaustive list.

However, some uses of drones have been hampered by regulatory issues. For example, in the United States, the Federal Aviation Administration has prohibited flying drones over people. This regulation eliminates many potential uses. With this regulation set to change, it opens some opportunities for drone use.

Traditional drones include a single chassis which may have one or more rotors attached. For example, a typical configuration is to have four rotors arranged in a planar fashion. The rotors may be attached by various strut arrangements back to a central chassis.

As with all aircraft, weight is a consideration, affecting performance. Drones with larger payloads may have to fly slower or have reduced flight time. Nearly all drones are battery powered, meaning that the more power is used from the battery by the rotors, the shorter the flight time, all things being equal.

Thus, drones, with limited flight times and size, may not be suitable for all uses. In fact, by design, some uses will be a very poor fit for drones. These uses may include uses where greater flight time is required, or where a larger done body would be an advantage.

For the foregoing reasons, there is a need for a drone system which can provide a stabilized payload which relatively larger than the drone powering the system.

### BRIEF SUMMARY

Disclosed herein is a drone trailer system for carrying a payload. The drone trailer system may include a control section able to pitch, roll, and yaw during flight. The control section may include at least one rotor rotated by an electric motor. The rotor may provide lift to the control section. The control section may further include at least one directional controller connected to the electric motor. The system may further include a flight controller electrically connected to the at least one directional controller, the flight controller sending signals to the directional controller, the signals controlling the pitch, roll and yaw of the control section. The system may further include an articulated joint connected to the control section. The system may further include a utility section connected to the articulated joint. The articulated joint may allow the control section to pitch and roll independently of the utility section. The utility section may include a rigid frame. The utility section may further include a stabilization device connected to the rigid frame. The stabilization device may provide stabilization to the utility section independent of the control section. The utility section may further include and a payload fixed to the rigid frame.

Further disclosed is a method for manufacturing a drone trailer system for carrying a payload. The method may include providing a control section. The control section may be able to pitch, roll, and yaw during flight. The control section may include at least one rotor rotated by an electric motor. The rotor may provide lift to the control section. The control section may further include at least one directional controller which may be connected to the electric motor. A flight controller may be electrically connected to the at least one directional controller. The directional controller may receive signals from the flight controller. The signals may control the pitch, roll and yaw of the control section. An articulated joint may be connected to the control section. A utility section may be connected to the rigid frame. The stabilization device may provide stabilization the utility section independent of the control section. The utility section may include a rigid frame. The utility section may further include a stabilization device. The stabilization device may be connected to the rigid frame. The stabilization device may provide stabilization to the utility section independent of the control section. The utility section may further include a payload, which may be fixed to the rigid frame.

Further disclosed is a drone trailer system for carrying a payload. The drone trailer system may include a control section. The control section may be able to pitch, roll, and yaw during flight. The control section may include at least one rotor. The rotor may be rotated by an electric motor. The rotor may provide lift to the control section. The control section may further include at least one directional controller. The directional controller may be connected to the electric motor. The drone trailer system may further include a flight controller. The flight controller may be electrically connected to the at least one directional controller. The flight controller may send signals to the directional controller. The signals may control the pitch, roll and yaw of the control section. The drone trailer system may further include an articulated joint. The articulated joint may be detachably connected to the control section. The articulated joint may be detachably connected to the control section by a mechanical fastener. The drone trailer system may further include a utility section. The utility section may be connected to the articulated joint. The articulated joint may allow the control section to pitch and roll independently of the utility section. The utility section may include a rigid frame. The utility section may further include a stabilization device. The stabilization device may be connected to the rigid frame. The stabilization device may provide stabilization to the utility section independent of the control section. The utility section may further include a payload. The payload may include at least one LED display. The LED display may be fixed to the rigid frame.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an exemplary embodiment of the system;

FIG. 2 shows a detail view of an articulated joint of the system;

FIG. 3 shows a detail view of an alternative articulated joint of the system;

FIG. 4 shows a perspective view of a first embodiment of the utility section of the system;

FIG. 5 shows a perspective view of a second embodiment of the utility section of the system;

FIG. 6 shows a perspective view of a third embodiment of the utility section;

FIG. 7 shows a perspective view of a fourth embodiment of the utility section;

FIG. 8 shows a perspective view of a fifth embodiment of the utility section;

FIG. 9 shows a perspective view of a sixth embodiment of the utility section;

FIG. 10 shows the embodiment of FIG. 9 with an LED panel payload;

FIG. 11 shows a schematic diagram of the system.

FIG. 12 shows a perspective view of a seventh embodiment of the utility section.

FIG. 13 shows a schematic diagram of the system.

### DETAILED DESCRIPTION

The detailed description set forth below in connection with the appended drawings is intended as a description of the presently preferred embodiment of a drone payload system and method, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.)

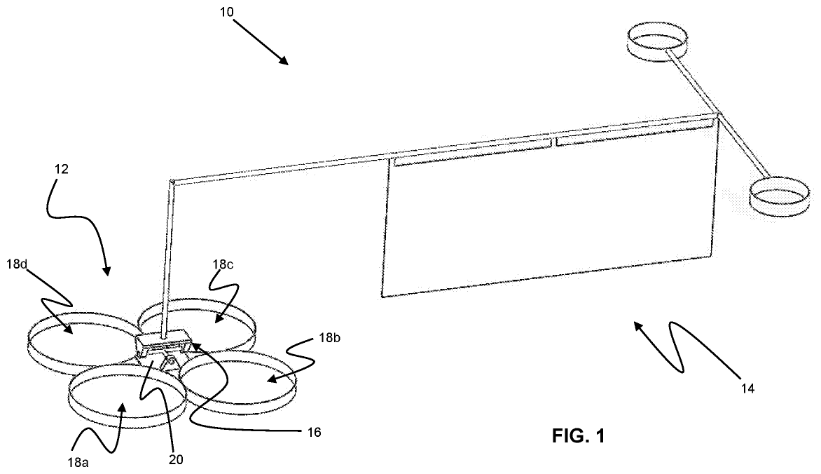

FIG. 1 is a schematic view of the system 10 according to aspects of the present disclosure. The system 10 may include a control section 12, and a utility section 14. The control section 12 may be joined to the utility section 14 by an articulated joint 16.

The control section 12 may include at least one rotor. In the exemplary embodiment shown, the control section 12 has four rotors 18a-d. Each of the four rotors 18a-d is connected by a strut to a chassis 20.)

Also connected to the chassis 20 is the articulated joint 16. For example, the articulated joint 16 may be a two or three axis gimbal. Alternatively, the articulated joint may be a collection of separate, that is not directly connected as in the case of a gimbal, rotatable joints in a single housing. Still further alternatively, some of the rotatable joints may be separated by an intervening structure, for example, a strut.)

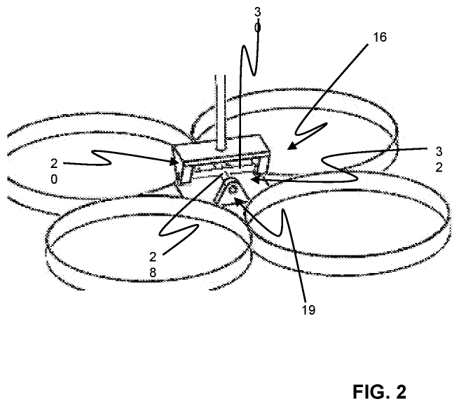

As show in FIG. 2, the articulated joint 16 may be fixed to the chassis or detachable from the chassis. When fixed, a first base portion 19 of the articulated joint 16, may move relative to a second base portion 20 of the articulated joint 16. The first base portion 19 may include two bases. Each base may have a geometric shape with at least one flat edge. The flat edge may be attached to a planar surface. The geometric shapes may be a triangle, a square, a rectangle, a trapezoid, or a shape with a combination of at least one flat edge and one or more curved edges. For example, the first base portion 19 may have two bases, with the flat edge of each base attaching to a planar portion of the chassis of the control section 12. The second base portion 20 may have two bases, with the flat edge of each base attaching to a planar portion of a plate forming part of the articulated joint 16, which is, in turn, attached to the utility section 14. As shown in FIG. 2, the first base portion 19 has two triangle shaped bases, and the second base portion has two triangle shaped bases. The first base portion 19 may connect to a first axel 28 and the second base portion 20 may connect to a second axel 30 of an axel group 32. The first base portion 19 may be attached to the control section 12, and the second base portion 20 may be attached to the utility section 14. This will allow the control section 12 to move relative to the utility section 14 on at least two axes.

The two axes may specifically be the axes along which the control section 12 pitches and rolls. Movement on two axes, specifically those corresponding to pitch and roll of the control section 12, is preferable when a user is operating the drone trailer system 10 in third person. Third person operation is when the user can see the system 10 well enough to determine the control section's 12 orientation with respect to yaw of the system 10.

In other embodiments, the articulated joint 16 may also move on three axes, the three axes corresponding to the pitch, roll, and yaw of the control section 12. Movement on all three axes is preferable when the operator is operating the drone in first person. First person operation is when the user makes use of an optical device on board the control section 12, for example, a camera to fly the system 10 because the system 10 is too far away to be able to determine its orientation by a user simply looking at it.

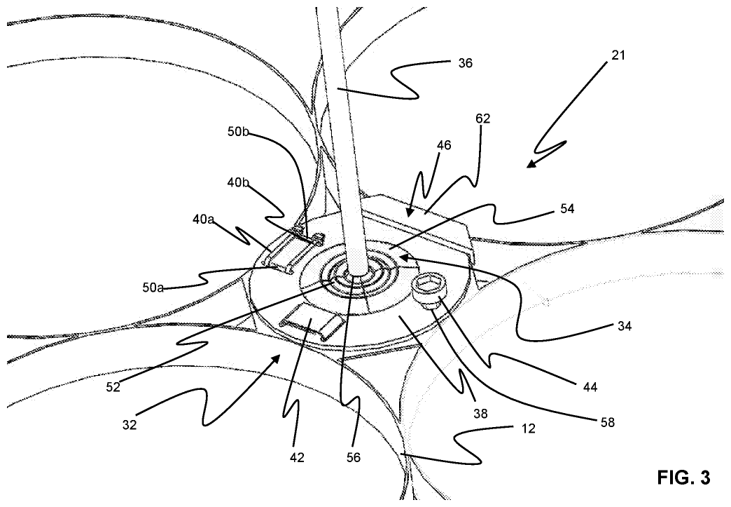

As shown in FIG. 3, the system may also have a detachable articulated joint 21. The detachable articulated joint 21 may allow attachment of the articulated joint 16 to the control section 12. Alternatively, the articulated joint 16 may be integrated with the control section 12, and the detachment is integrated with the utility section 14. The connection may be made using mechanical fasteners. For example, screws, pins, latches, clamps, zip ties, hook and loop fastener strips, or other mechanical fasteners. Alternatively, two or more of the mechanical fastener types may be used.

As shown in FIGS. 3 and 1, the detachable articulated joint 21 is integrated with the utility section 14, and may be attached to the control section 12 using one or more mechanical fasteners 32. The detachable articulated joint 21 may include a flexible portion 34 which allows the strut 36 attached to the flexible portion 34 to move on two axes. As the flexible portion 34 flexes, the strut 36 may cant the flexible portion 34 flexes to allow the control section 12 to pitch and roll while the utility section 14 remains stable. This allows the control section 12 to pitch and roll relative to the control section. In other embodiments, the strut 36 may be rotationally fixed within the flexible portion 34, preventing yaw of the control section relative to the strut. The flexible portion 34 may include concentric raised portions. As shown in FIG. 3, the flexible portion 34 may include an inner raised portion 52 and an outer raised portion 54. When the strut 36 is moved in any direction, one side of the raised portions may compress, and the other side of the raised portions may extend. The strut 36 may include a groove around a circumference of the cross section of the strut which may accommodate an inner edge 56 of the flexible portion 34. The inner edge 56 may define a hole in the center of the flexible portion 34. The groove and inner edge 56 arrangement prevents the strut 36 from separating from the flexible portion 34 when the strut 36 moves.

The detachable articulated joint 21 may include a rigid disc shaped plate 38 in the center of which is placed the flexible portion 34. While a disc shaped plate 38 is shown, it is to be understood that the plate may have other shapes. By way of example and not limitation, the plate may be square, triangular, rectangular, trapezoid, or any other shape which allows the other components to function. Alternatively, the plate may not be a plate, it may be a more three dimensional structure such as a pyramid, or other shape which allows function of the remaining components. The plate 38 may be attached to the control section 12 by a plurality of mechanical fasteners 32. Specifically, the plate 38 is attached by a pair of zip ties 40a, 40b, a hook and loop fastener strip 42, a screw 44, and a clamp 46. Each of the mechanical fasteners 32 may be spaced evenly from the others. For example, as in the embodiment shown in FIG. 3, with four mechanical fasteners 32, each fastener is spaced at approximately 90 degrees from the other fasteners. The mechanical fasteners 32 may be located between a perimeter edge 40 of the plate 38 and the flexible portion 34. Although a combination of mechanical fasteners 32 is shown, in other embodiments, a single type of fasteners may be used exclusively. In addition, although four mechanical fasteners are shown, it is to be understood that there may be as few as one, or as many as 100.

When one or more zip ties 40a, 40b are used, each zip tie may be looped through two slots in the plate 38. The zip ties 40a, 40b may pass through corresponding slots 50a, 50b or raised bars placed on the control section 12. When the zip ties 40a, 40b are pulled tight and fastened, the detachable articulated joint 21 is pulled tight to the control section 12. While two zip ties 40a, 40b are shown in FIG. 3, in other embodiments, a single zip tie may be used in one location, or more than two zip ties may be used in a single location.

Similarly, when one or more hook and loop fastener strips 42 are used, the strips may pass through a pair of slots 48a, 48b in the plate 38. The slots in the plate may correspond to a pair of slots in the control section 12. The one or more hook and loop fastener strips 42 may loop through both, and then the one or more strips is pulled tight and fastened, the arrangement provides a tight connection to the control section 12. While one hook and loop fastener strip 42 is shown in FIG. 3, in other embodiments, two or more strips may be used in a single location.

As mentioned above and is shown in FIG. 3, the mechanical fasteners may include a screw 44. The screw 44 may include a variety of head types, which may be driven by a correspondingly different driver. However, each of the screws 44 will have a larger head than a hole 58 in the plate 38 through which a shaft 60 of the screw passes. The screw 44 mates with a corresponding threaded hole in the control section 12. Because the head of the screw 44 is larger than a hole 58 in the plate 38, the head of the screw holds the plate to the control section 12. While one screw 44 is shown in FIG. 3, in other embodiments, two or more screws may be used in a single location, or in multiple locations around the plate 38.

The detachable articulated joint 21 may also be held to the control section by a clamp 46. The clamp 46 may be attached to the control section 12 via mechanical fasteners, adhesives, or welding, or other means which prevent the clamp from moving relative to the control section. The clamp 46 may be integral with a hinge. The hinge may include a first plate fixed to the control section, and a second plate which rotates relative to the first plate. A pin may connect the first plate to the second plate, and the second plate may rotate around the pin. The clamp 46 further includes a clamping shoe. The clamping shoe 62 may include a variety of shapes including the trapezoidal plate and sidewall configuration shown in FIG. 3. The clamping shoe 62 may have a plate having a curved edge which matches a curvature of the control section housing or may have any other of a variety of shapes. The clamp 46 may include a first piece of a hook and loop fastener on the underside of the trapezoidal plate, which engages a second piece of hook and loop fastener on the plate 38. Alternatively, or in addition, the hinge of the clamp 46 may include a lock which prevents rotation of the second plate relative to the first plate. While one clamp 46 is shown in FIG. 3, in other embodiments, two or more clamps may be used in multiple locations around the plate 38.

The ability to separate the utility section 14 from the control section 12 offers advantages. First, the same control section 12 may be connected to different utility sections depending on requirements. For example, the system 10 may be flown with a first utility section set up with an electronic sign as a payload. Then, that first utility section may be detached, and a second utility section attached with a payload of a printed sign for a second flight. Payloads types which may be included in the utility section are discussed in greater detail below.

A detachable utility section 14 offers further advantages. Being able to split the system 10 in to two parts reduces any single dimension which makes the system 10 easier to transport. Moreover, if requirements dictate, the control section 12 may be flown without the utility section 14 attached. This creates even further flexibility in flight profiles which the system 10 may meet.

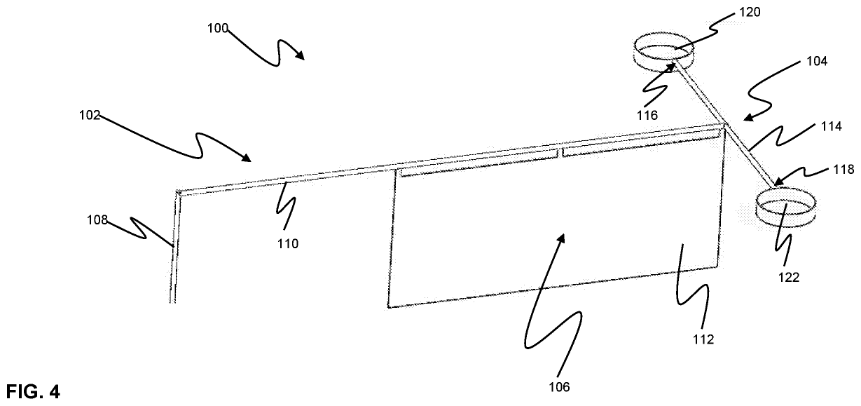

Each embodiment of the utility section may be used with either a fixed articulated joint or a detachable articulated joint. One exemplary embodiment of the utility section 100 may include a rigid frame 102, a stabilization device 104, and a payload 106. The rigid frame 102 may have at least one vertical strut 108 and at least one horizontal strut 110. The at least one vertical and at least one horizontal strut may be arranged so that the combination of vertical and horizontal struts may support a payload 106, for example, one or more panels 112 with graphics printed on the panel. The one or more panels 112 may be planar or curved. In the exemplary embodiment of FIG. 4, the payload 106 is a single planar panel 112 which is attached to a horizontal strut 110.

The exemplary embodiment of FIG. 4 further includes a stabilization device 104. As shown, the stabilization device 104 includes a second horizontal strut 114. The second horizontal strut 114 may include a first end 116 and a second end 118. Attached to the first end 116 is a first stabilizing rotor 120, and attached to the second end 118 is a second stabilizing rotor 122. In addition to providing lift for the utility section 100, the first stabilizing rotor 120 and second stabilizing rotor 122 hold the utility section 100 stable so that they payload 106 may be easily observed. That is, in flight, the control section may pitch or roll, but the utility section 100 remains stable even as the control section rolls from side to side. The first stabilization rotor and the second stabilization rotor may be powered by the power on the control section, or may have an independent source of power, for example, a battery on the utility section.

The vertical and horizontal struts may be made of a metal, including an alloy, or a composite material which is chosen for a strength to weight ratio which will survive the stressors of any flight profile, but will not unnecessarily need the use of power to keep aloft. Similarly, the payload 106 material may be chosen for rigidity and light weight. The requirement for rigidity is not as great as it is for the vertical and horizontal struts. The material of the payload 106 needs to be rigid enough to hold its shape when subjected to wind forces or air currents as the system moves through the air. The payload 106 may be a heavyweight paper, such as a cardboard, a plastic, a composite, or any other material which provides the combination of low weight and sufficient rigidity. The second horizontal strut 114 may be attached to the rigid frame 102 using welding, an adhesive, or a mechanical fastener, or a combination thereof. The payload 106 may be attached to the rigid frame 102 by a mechanical fastener so the payload may be changed out when required. Mechanical fasteners may include hook and loop fastener strips, nut and bolt combinations, or any other mechanical fastener which holds the payload 106 securely to the rigid frame 102.

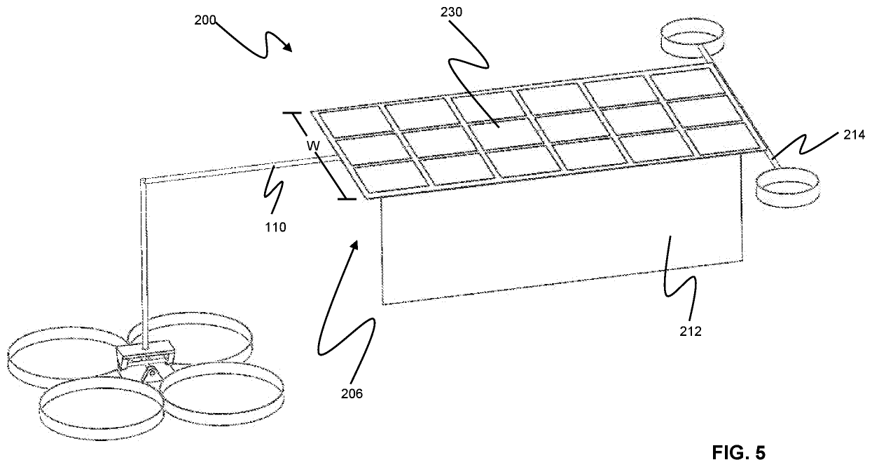

A second exemplary embodiment of the utility section 200 is shown in FIG. 5. The second exemplary embodiment is similar to the first exemplary embodiment. Noticeably, a solar panel 230 has been added to the payload 206. The solar panel 230 may be placed perpendicular to a graphics panel 212 of the payload 206 so that a first edge of the graphics panel 212 connects to a first surface of the first horizontal strut 210 and the solar panel connects to a second surface of the first strut 210 midway across a width W of the solar panel 230. This combination, when viewed from a first end or a second end of the combination of the solar panel 230 and the graphics panel 212 will form a “T” shape. Each of the solar panel and the graphics panel may be rigid, or the solar panel 230 may be flexible. For example, some solar panels may simply be attached to the struts and the solar panel will have sufficient rigidity to retain its shape. In contrast, other solar panels may be placed in tension by attaching the solar panel to the rigid frame at points along the first horizontal strut as described in the first exemplary embodiment, but also attaching the solar panel 230 to the second horizontal strut 214 at one or more points. When attached in this manner, the solar panel may be placed in tension, helping the solar panel to retain its shape. The solar panel may also be attached to both the first horizontal strut 210 and the second horizontal strut 214, but not placed in tension. The solar panel may be attached to the first horizontal strut 210 and the second horizontal strut 214 by for example, welding, or by mechanical fasteners at a plurality of locations, or by adhesives, or by any method that ensures that the solar panel 230 will remain attached while the utility section 200 is in use.

The graphics panel 212 may include any type of printed or formed graphics. By way of example and not limitation, the graphics panel may be a panel with printing, which may be lit by an external source, the graphics panel may be a neon sign, the graphics panel may be a lighted sign with a translucent panel and interior lighting. Regardless of the precise form the graphics panel takes, it includes some type of information.

The solar panel may be made of various materials. In some embodiments the solar panel may be a generally rigid silicon wafer. Still other solar panels may be made of flexible laminated materials. Again, the chosen materials may be a tradeoff of weight and rigidity. However, rigidity of the solar panel 230 is less critical than for some other components.

The solar panel 230 may provide power directly to rotors or other stabilization devices or flight controls on the utility section 200. Alternatively, the solar panel 230 may provide charge to a battery either on the control section, or on the utility section, or both. The addition charge provided by the solar panel 230 may increase flight times or power the payload.

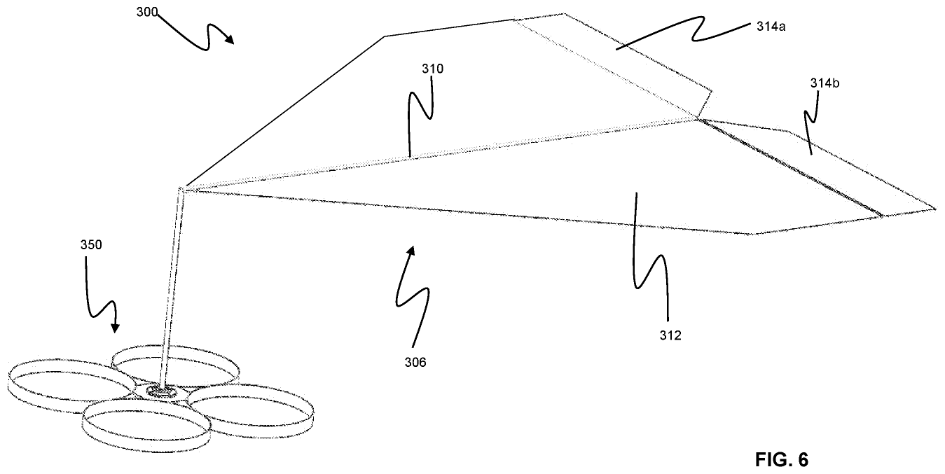

A third exemplary embodiment is shown in FIG. 6. In this embodiment, the payload 306 includes an aerodynamic structure 312. In the embodiment showing in FIG. 6, the aerodynamic structure is a wing. Here, the payload 306 can serve a dual purpose, as the aerodynamic structure 312 can provide lift and stability, and bear graphics in a manner similar to payload in the previous embodiments. In the case of this embodiment, the graphics may be placed on a bottom surface of the aerodynamic structure. Moreover, a graphics panel similar to the graphics panel of the previous two embodiments may be added to this embodiment was well. To provide stability, the aerodynamic structure 312 may have a pair of ailerons 314a, 314b placed on a trailing edge of the aerodynamic structure. The ailerons 314a, 314b can provide passive stability for the utility section 300 as the system moves through the air. The control of the ailerons 314a, 314b may be tied in to the control of the control unit so that the ailerons react to keep the utility section 300 stable as the control section 350 pitches and rolls. Power for moving actuators which control the ailerons 314a, 314b may be brought via wire from the control section 350 or powered from a separate power source on the utility section 300. The actuators may be attached to a first horizontal strut 310. This provides a rigid attachment point for the actuators. The ailerons themselves may include an attachment to a rigid leading edge. That is, each aileron may have a rigid structure which attaches to a second or third horizontal structure around which the rigid leading edge may rotate. For example, the second or third strut may have a circular cross section, and the leading edge may be a sleeve with an inner diameter essentially matching the outer diameter of the circular cross section. The actuator may also attach to other structures. It is not critical that the actuators where the actuators are attached. In some embodiments, the actuator may be built in to the ailerons itself.

The material for the aerodynamic structure 312 may be a foam such as Styrofoam, a plastic, a composite, a wood, or a paper. The aerodynamic structure may be formed of a single unitary piece of this material and then attached to the first horizontal strut 310 using, for example, an adhesive, or mechanical fasteners. The aerodynamic structure 312 may be attached to a top surface of the first horizontal strut 310. The aerodynamic structure 312 may be attached using an adhesive or mechanical fasteners.

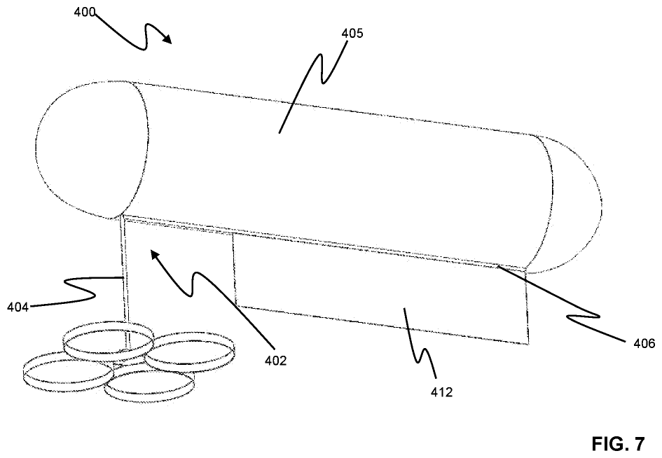

A fourth exemplary embodiment is shown in FIG. 7. The utility section 400 may include an volumetric aerodynamic body 405 filled with a lighter than air gas. The utility section 400 may have a rigid frame 402 similar to that of previous embodiments. The rigid frame 402 may include a vertical strut 404 and a horizontal strut 406. The volumetric aerodynamic body 405 may be attached to a top surface of Similar to the first and second exemplary embodiments, this embodiment may include a graphics panel 412. The graphics panel 412 may be attached to the horizontal strut 406 or directly to the volumetric aerodynamic body 405. Similar to the first and second embodiments, the graphics panel 412 may be attached to the horizontal strut 406 using mechanical fasteners.

Alternatively, the horizontal strut 406 may include a slot extending the length of the horizontal strut, and the depth of the strut except for a top surface portion between the slot and the gas filled volumetric aerodynamic body 405. The horizontal strut 406 may further include a number of set screws placed at intervals along the horizontal strut. The set screws may have corresponding holes which allow each of the set screws to enter the slot essentially perpendicular to an axis defining the depth of the slot. When a graphics panel 412 is placed in the slot, the set screws may be tightened and the friction force created by the set screws between the slot, the graphics panel and the set screws will hold the graphics panel in the slot. Although set screws are shown, the attachment may be done using alternative mean. Alternatively, the graphics panel may be attached using adhesives or clamps. The clamps may be located in similar locations to that of the set screws.

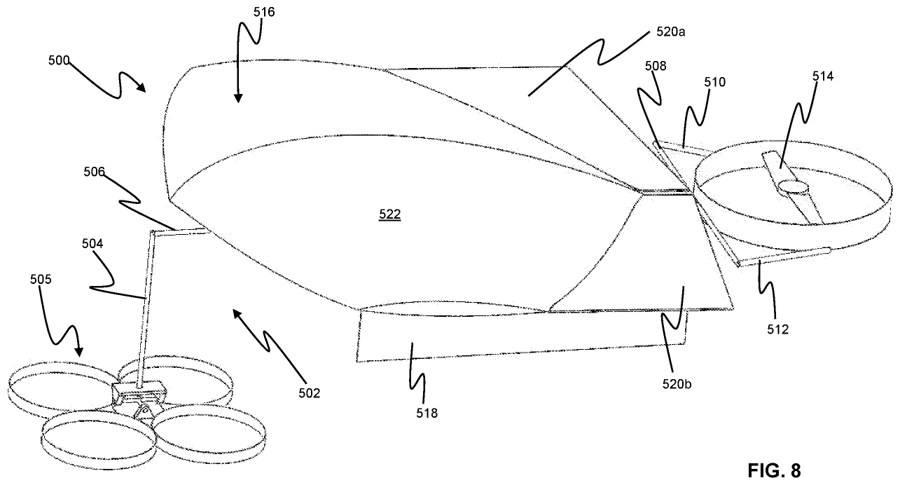

A fifth exemplary embodiment is show in FIG. 8. The embodiment of FIG. 8 combines the concepts of the previous embodiments. The utility section 500 includes a rigid frame 502, with a vertical strut 504, a first horizontal strut 506, a second horizontal strut 508, and a first connector 510 and a second connector 512.

The second horizontal strut 508, the first connector 510, and the second connector 512 support a rotor 514 which serves to stabilize the utility section 500 movement relative to the control section 505. The rotor 514 may be powered by a battery which powers the control section 505, or may be powered by a separate battery included in the utility section 500. The rotor 514 also provides lift to the utility section 500. Alternately, the rotor 514 may be connected to any portion of the structure, with or without additional struts.

The utility section 500 may further include a passive volumetric aerodynamic lifting body 516 similar to the aerodynamic structure of the third embodiment. The volumetric aerodynamic lifting body 516 may include both elements of the aerodynamic structure and the volumetric aerodynamic body of the fourth embodiment. The volumetric aerodynamic lifting body 516 includes a lift providing section 522 which includes a gas filled volumetric aerodynamic body shaped to provide lift when the system is in motion through the air. Also similar to the third embodiment, the volumetric aerodynamic lifting body 516 includes two ailerons 520a, 520b which further provide stability to the utility section 500, preventing movement of the utility section 500 relative to the control section 505. Similar to the fourth embodiment, the volumetric aerodynamic lifting body 516 is attached to the first horizontal strut 506. The aero dynamic body 516 may be attached using adhesives or fasteners.

A graphics panel 518 is also attached to the first horizontal strut 506. The graphics panel 518 may be attached using any of the methods described above for any of the previous embodiments.

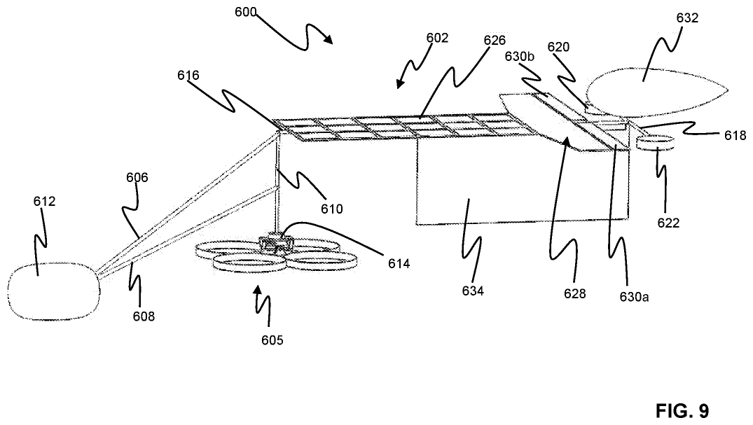

A sixth exemplary embodiment is show in FIG. 9. The drone trailer system 600 includes a utility section 602 and a control section 605. This embodiment includes a number of the features of other embodiments, as well as employing gravity and weight distribution to help stabilize the utility section 602. The utility section 602 includes a first connector 606 and a second connector 608. A first end of the first connector and a first end of the second connecter connect to a vertical strut 610 or to any other portion of the utility section 602. The first connector 606 and second connector 608 may attach to the vertical strut 610 using, for example, welding, adhesives, or mechanical connectors. A second end of the first connector 606 and a second end of the second connector 608 connect on a second end to a counterweight 612. The counterweight 612 uses gravity to help stabilize the utility section 602. The counterweight 612 has a mass which is calibrated to offset the mass of the utility section 602 using the connection of the utility section to the articulated joint 614 as a fulcrum. The articulated joint 614 may be either fixed or detachable.

Similar to other previous embodiments, the utility section may include a first horizontal strut 616 and a second horizontal strut 618. The first horizontal strut 616 may be connect on a first end to the vertical strut 610 and on an opposite, second, end to the second horizontal strut 618. The struts may be connected using, for example, welding, adhesives, or mechanical fasteners. The section horizontal strut 618 has a first end and a second end. A first rotor 620 may be connected to the first end and a second rotor 622 may be connected the second end of the second horizontal strut 618.

The utility section 602 may include a solar pane 626 which attaches to the utility section 602 in the same manner described above for previous embodiments. The solar panel 626 may provide power, recharging of batteries, or both in the manner described above for previous embodiments.

The utility section 602 may further include an volumetric aerodynamic lifting body 628 which provides lift passively and includes control surfaces, for example, ailerons 630a, 630b which help provide stability to the utility section, preventing movement relative to the control section 605. The volumetric aerodynamic lifting body 628 is similar to the aerodynamic bodies of other embodiments and functions as described for those embodiments.

The utility section 602 may further include a gas filled volumetric aerodynamic body 632. Here, the gas filled volumetric aerodynamic body 632 is not purely providing lift or stabilization solely, but in conjunction with the other features included with the utility section 602. However, the general features and operation are the same for gas filled volumetric aerodynamic bodies in other embodiments described above.

Each of the rotors, aerodynamic bodies, and gas filled volumetric aerodynamic bodies may be referred to as a stabilization device. Where each of these features of a rotor, volumetric aerodynamic lifting body, and gas filled volumetric aerodynamic body are used in a combination of two or more features, the combination may also be referred to as a stabilization device.

The utility section may include a graphics panel 634. The graphics panel 634 is similar to that of the other embodiments, and may be attached to the first horizontal strut 616 in the manner described for the other embodiments above or any other part of the utility section 602.

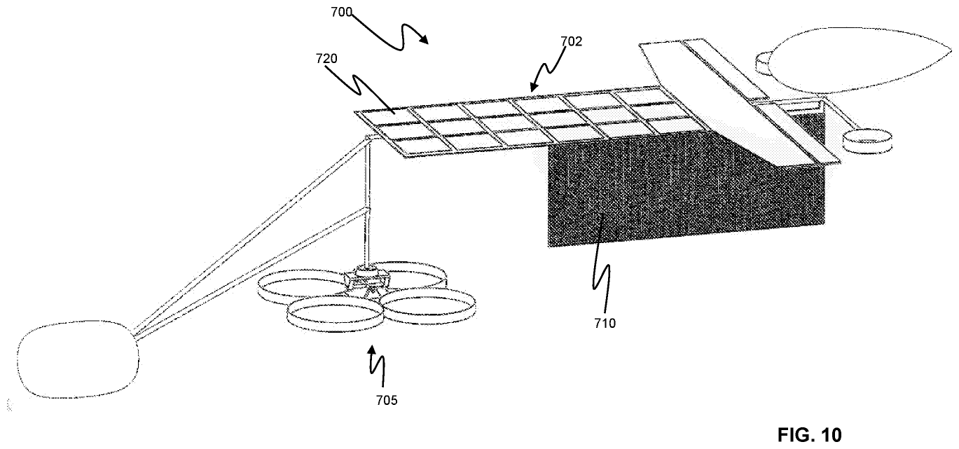

FIG. 10 shows an exemplary embodiment similar to the previous one. The system 700 includes a control section 705. Here, the graphics panel is a plurality of light emitting diodes (LEDs) arranged in a pattern. For example, the LEDs may be arranged in column and rows. It is to be understood that an LED panel may be substituted for any graphics panel of any previous embodiment. The LED control and power may be included in the control section or may be included in the utility section. The power may be provided by a battery, or, as shown in this embodiment, a solar panel 720.)

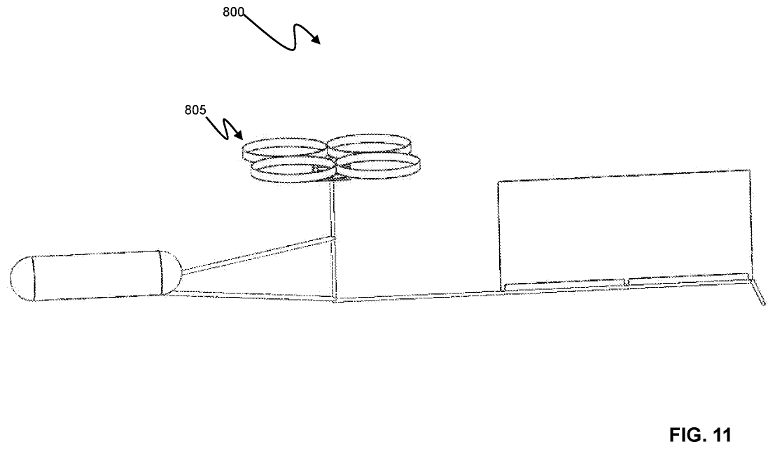

FIG. 11 an exemplary embodiment similar to that in FIG. 10. While the structure of the system 800 in FIG. 11 is similar to that of FIG. 10, the structure has been rearranged so that the structure is largely or entirely below the control section 805. Because the center of gravity in this system 800 is below the control section 805, the system is more stable, and the entire structure of the system 800 may be used to effect the counterbalance. Potential benefits include overall lower mass of the system 800.

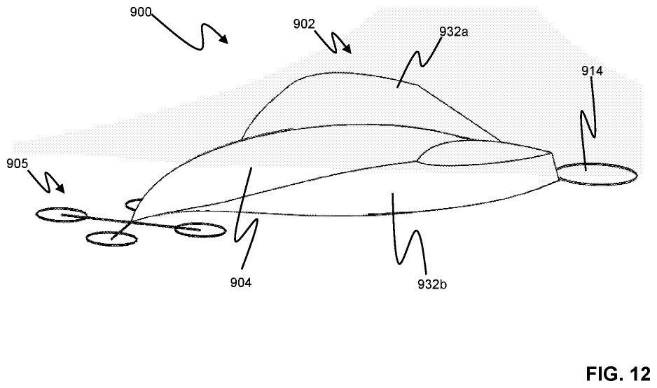

Another embodiment is shown in FIG. 12. The system 900 may include a control section 905 and a utility section 902. The utility section 902 does not include a rigid frame on to which other components are mounted, but rather uses a unibody design. The utility section may include an aerodynamic structure 904 which attaches to the control section 905. The utility section 902 may further include one or more volumetric aerodynamic bodies 932a, 932b. The utility section 902 may further include one or more rotors 914 for active stabilization. All of the aerodynamic structure 904, the one or more volumetric aerodynamic bodies 932a, 932b, and the rotor 914 include rigid portions and connections to one another. All of the aerodynamic structure 904, the one or more volumetric aerodynamic bodies 932a, 932b, and the rotor 914 may be integrated with one another, with the aerodynamic structure 904 attaching to the control section 905. Alternatively, the utility section may have a single aerodynamic structure, or a single volumetric aerodynamic body, either of which may be used with or without a rotor.

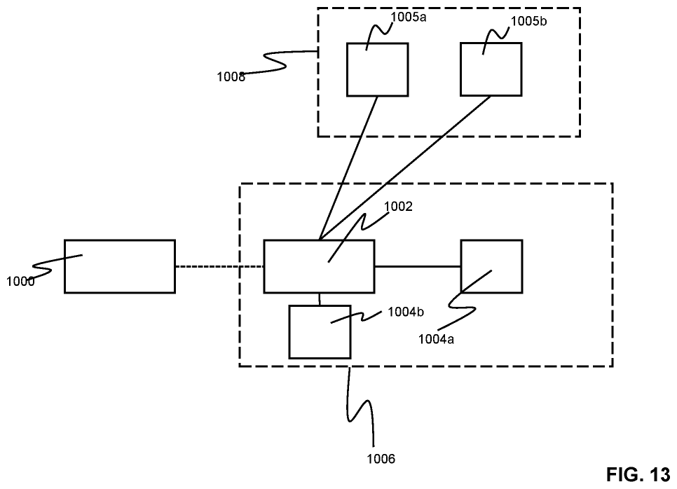

In operation, a user may use a flight controller 1000 to control the control section 1006 of the system. The flight controller 1000 may be a remote control which sends wireless signals to a direction controller 1002 which is included with the control section. The flight controller 1000 may be operated by a user. Alternatively, the flight controller 1000 may include a set of instructions stored in a memory and executed on a processor on the control section of drone trailer system. In either case, the flight controller 1000 sends signals with commands and data to the direction controller 1002, either through a wired or wireless connection. The signals may include commands which cause electric motors 1004a, 1004b to rotate and different speeds, providing differential thrust to pitch, roll, and yaw the control section 1006. Although two electric motors are shown in FIG. 13, it is understood that there may be more than two rotors, or less than two rotors, with four electric motors, and a corresponding four rotors being most common.

The flight controller 1000 also provides signals to the direction controller 1002 for any active stabilization devices which may be included in the utility section 908. Active stabilization devices 1005a, 1005b include rotors powered by electric motors and ailerons. Although an active stabilization device including two features 1005a, 1005b is shown in FIG. 13, it is understood that there may be more than two features or less than two features. For example, a utility section may have an active stabilization device including a single electric motor and rotor, another active stabilization device may include two electric motors and two rotors, or two ailerons.

A user may use the flight controller in real time to send these commands to fly the control section and maintain the stability of the utility section relative to the control section, or they may be programmed in to a memory and executed on a processor as described above.

The above description is given by way of example, and not limitation. Given the above disclosure, one skilled in the art could devise variations that are within the scope and spirit of the invention disclosed herein, including various ways of using sensors to control the operation of the system. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A drone trailer system for carrying a payload, comprising:
a control section able to pitch and roll during flight, the control section including at least one rotor rotated by an electric motor, the rotor providing lift to the control section, at least one directional controller connected to the electric motor;
a flight controller electrically connected to the at least one directional controller, the flight controller sending signals to the directional controller, the signals controlling the pitch and roll of the control section;
an articulated joint connected to the control section;
a utility section connected to the articulated joint, the articulated joint allowing the control section to pitch and roll independently of the utility section, the utility section including;
a stabilization device connected to the rigid frame, the stabilization device providing stabilization to the utility section independent of the control section; and
a payload fixed to the rigid frame.

2. The system of claim 1, wherein the articulated joint is detachable from the control section.

3. The system of claim 1, wherein the payload includes an LED array.

4. The system of claim 1, wherein the payload includes a solar panel.

5. The system of claim 4, wherein the solar panel is electrically connected to a battery.

6. The system of claim 1, wherein the stabilization device includes at least one rotor.

7. The system of claim 1, wherein the stabilization device includes at least one passive lift producing component

8. They system of claim 1, wherein the stabilization device provides lift to the utility section.

9. A method for manufacturing a drone trailer system for carrying a payload, comprising:
providing a control section, the control section able to pitch, roll, and yaw during flight, the control section including at least one rotor rotated by an electric motor, the rotor providing lift to the control section, at least one directional controller connected to the electric motor;
electrically connecting a flight controller to the at least one directional controller, the directional controller receiving signals from the flight controller, the signals controlling the pitch, roll and yaw of the control section;
connecting an articulated joint to the control section;
connecting a utility section to the rigid frame, the stabilization device providing stabilization the utility section independent of the control section, the utility section including;
a rigid frame;
a stabilization device connected to the rigid frame, the stabilization device providing stabilization to the utility section independent of the control section; and
a payload fixed to the rigid frame.

10. The method of claim 9, wherein the stabilization device may roll the utility section relative to the control section.

11. The method of claim 9, wherein the stabilization device provides lift to the utility section.

12. The method of claim 9, wherein the payload includes one or more LED displays.

13. The method of claim 12, wherein the LED displays face opposite directions.

14. A drone trailer system for carrying a payload, comprising:
a control section able to pitch and roll during flight, the control section including at least one rotor rotated by an electric motor, the rotor providing lift to the control section, at least one directional controller connected to the electric motor;
a flight controller electrically connected to the at least one directional controller, the flight controller sending signals to the directional controller, the signals controlling the pitch and roll of the control section;
an articulated joint detachably connected to the control section by a mechanical fastener;
a utility section connected to the articulated joint, the articulated joint allowing the control section to pitch and roll independently of the utility section, the utility section including;
a rigid frame;
a stabilization device connected to the rigid frame, the stabilization device providing stabilization to the utility section independent of the control section; and
a payload including at least one LED display fixed to the rigid frame.

15. The system of claim 14, including at least two LED display facing in opposite directions.

16. The system of claim 15, wherein the payload further includes a first panel having a first surface and an opposite facing second surface, and wherein a first LED display is fixed to the first surface and a second LED display is fixed to the second surface.

17. The system of claim 16, wherein the payload further includes a second panel placed perpendicularly along an edge of the first panel and attached to the first panel so that the attached first panel and second panel for a T shape when viewed from a first end or a second end.

18. The system of claim 14, wherein stabilization device includes a gas filled volumetric aerodynamic body.

19. The system of claim 14, wherein the stabilization device includes at least one rotor.

20. The system of claim 19, wherein the at least one rotor provides lift to the utility section.
